(19) United States
(12) Patent Application Publication
(10) Pub. No.: US 2026/0161445 A1
(43) Pub. Date: Jun. 11, 2026

(54) Technique to Execute Code Written for an RTOS Environment from a Bare Metal Environment

(71) Applicant: Silicon Laboratories Inc., Austin, TX (US)

(72) Inventors: Jean Francois Deschenes, Ste-Marthe-sur-le-lac (CA); Christian Galante, LaSalle (CA); Louis Levesque, Montreal (CA)

(21) Appl. No.: 18/975,177

(22) Filed: Dec. 10, 2024

(51) Int. Cl. G06F 9/48; G06F 9/30; G06F 9/455

(52) U.S. Cl. CPC G06F 9/4881; G06F 9/30043; G06F 9/45504; G06F 9/485

(57) ABSTRACT

A system and method that allows instructions and tasks written for an RTOS environment to be executed in a bare metal environment without any modifications is disclosed. An abstraction layer is used to implement traditional RTOS functions such as blocking and releasing calls. In addition, a pseudo RTOS process is added to the main infinite loop of the bare metal environment which is used to ensure that the various tasks are executed in a sequential manner. Context for each task and for the pseudo RTOS process is stored in a dedicated region of memory and is loaded into the processing unit when needed.

### FIELD

This disclosure describes systems and methods for executing code written for an RTOS environment from a bare metal environment.

### BACKGROUND

Many devices utilize processing units to perform their desired operation. In certain situations, there are a plurality of different tasks that are performed by these processing units to achieve the desired operation. These tasks may include complying with network protocols, servicing interrupts and other tasks.

Often, in these devices, a real time operating system (RTOS) is used to manage these tasks. Specifically, the RTOS may be aware of the priority of each task, and may use this information to determine the scheduling of the tasks. Further, the RTOS is also aware of when a task is blocked. This may be because it is waiting for some event, such as an interrupt, or it is waiting on some other construct, such as a semaphore or a mutex. The RTOS is also able to use this information to determine which task to execute next. Further, these constructs may typically be managed by the RTOS. For example, a task may call an RTOS function to check the status of a semaphore or mutex.

There are various different RTOS that are commonly used. Consequently, a layer of abstraction may be included between the tasks and the RTOS. In other words, the tasks may use generic calls to the RTOS functions. The abstraction layer then translates these generic calls to the instructions needed for the specific RTOS used in this environment.

Despite the prevalence of RTOS systems, there are some developers that prefer to use bare metal environments. A bare metal environment is one where there is no underlying RTOS. Rather, all of the different tasks simply execute one after another in an infinite loop.

Tasks that are written for an RTOS environment typically require features and functionality that is not available in a bare metal environment. However, it is an enormous and tedious task to have a developer create two sets of code for a specific task; one for RTOS environments and one for bare metal environments.

Therefore, it would be beneficial if there was a system and method by which instructions and tasks written for an RTOS environment may be executed in a bare metal environment without any modifications.

### SUMMARY

A system and method that allows instructions and tasks written for an RTOS environment to be executed in a bare metal environment without any modifications is disclosed. An abstraction layer is used to implement traditional RTOS functions such as blocking and releasing calls. In addition, a pseudo RTOS process is added to the main infinite loop of the bare metal environment which is used to ensure that the various tasks are executed in a sequential manner. Context for each task and for the pseudo RTOS process is stored in a dedicated region of memory and is loaded into the processing unit when needed.

According to one embodiment, a method to allow a plurality of tasks that are written for a real time operating system (RTOS) environment to execute in a bare metal environment is disclosed. The method comprises executing an infinite loop that comprises a user application and a pseudo RTOS process; wherein the pseudo RTOS process cycles through each of the plurality of tasks that are ready to execute; and wherein when the pseudo RTOS process switches to a first of the plurality of tasks, its context is saved in a first designated region of memory; and wherein when the first of the plurality of tasks is blocked, the context stored in the first designated region of memory is restored to allow the pseudo RTOS process to continue execution. In some embodiments, the pseudo RTOS process loads context stored in a second designated region of memory to switch to the first of the plurality of tasks. In certain embodiments, setjmp( ) and longjmp( ) instructions are used to save and load context to and from designated regions of memory. In some embodiments, the first of the plurality of tasks becomes blocked after performing a pending/blocking call. In certain embodiments, the pending/blocking call comprises: performing a computation on a selected construct; and if the selected construct is not available: storing context of the first of the plurality of tasks in the second designated region of memory; and loading the context from the first designated region of memory to switch to the pseudo RTOS process. In certain embodiments, the pending/blocking call further comprises: indicating that the first of the plurality of tasks is not ready to execute. In some embodiments, the first of the plurality of tasks becomes ready after a second of the plurality of tasks executes a post/release call. In certain embodiments, the post/release call comprises: performing a computation on the selected construct; and marking the first of the plurality of tasks as ready. In some embodiments, the plurality of tasks utilize RTOS functions, wherein the plurality of tasks utilize RTOS calls that are coded as application programming interfaces (APIs), and an abstraction layer is provided to allow the RTOS functions to be performed in the bare metal environment.

According to another embodiment, a method to allow a plurality of tasks that are written for a real time operating system (RTOS) environment to execute in a bare metal environment is disclosed. The method comprises including RTOS functions in the plurality of tasks, wherein each RTOS call is coded as application programming interfaces (APIs); and providing an abstraction layer, wherein the abstraction layer comprises instructions that to allow the RTOS functions to be performed in the bare metal environment. In some embodiments, one of the RTOS calls comprises a pending/blocking call. In certain embodiments, the pending/blocking call comprises: performing a computation on a selected construct; and if the selected construct is not available: storing context of a task that is executing in a second designated region of memory; and
loading context from a first designated region of memory to switch to a pseudo RTOS process. In certain embodiments, the pending/blocking call further comprises: indicating that the task is not ready to execute. In some embodiments, a pseudo RTOS process is used to cycle through all tasks that are ready to execute to allow each task to execute once. In some embodiments, the plurality of tasks and the pseudo RTOS process use setjmp( ) and longjmp( ) instructions to switch context. In some embodiments, one of the RTOS calls comprises a post/release call. In certain embodiments, the post/release call comprises: performing a computation on a selected construct; and marking a task or a user application that was waiting on the selected construct as ready to execute.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a typical architecture that is used to execute an RTOS;

FIG. 2 shows the main loop of the bare metal environment;

FIGS. 3A-3B show the flow chart of the pseudo RTOS process;

FIG. 4 shows the flowchart for pending/blocking calls;

FIG. 5 shows the flowchart for post/release calls; and

FIGS. 6A-6B show the operation of the setjmp( ) and longjmp( ) instructions.

### DETAILED DESCRIPTION

This disclosure describes a technique whereby tasks that were written to execute in a Real Time Operating System (RTOS) environment may be executed in a bare metal environment.

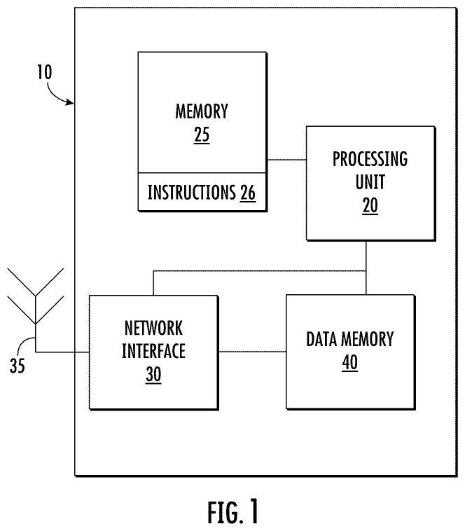

FIG. 1 shows the architecture of a typical network device that may use an RTOS. The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the network device 10 to perform the functions described herein. For example, the pseudo RTOS process and the associated tasks described herein may be stored in this memory device 25. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support any wireless network, such as Bluetooth, Wi-Fi, networks utilizing the IEEE 802.15.4 specification, such as Zigbee and Wi-SUN, networks utilizing the IEEE 802.15.6 specification, and wireless smart home protocols, such as Z-Wave. Further, the network interface 30 may also support a proprietary or custom wireless network.

The network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless network. Although not shown, the network device 10 also has a power supply, which may be a battery or a connection to a permanent power source, such as a wall outlet.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the network device 10, not its physical configuration. Further, while the above describes a network device, it is understood that this technique is applicable to any device that seeks to execute tasks that were written for an RTOS environment in a bare metal environment.

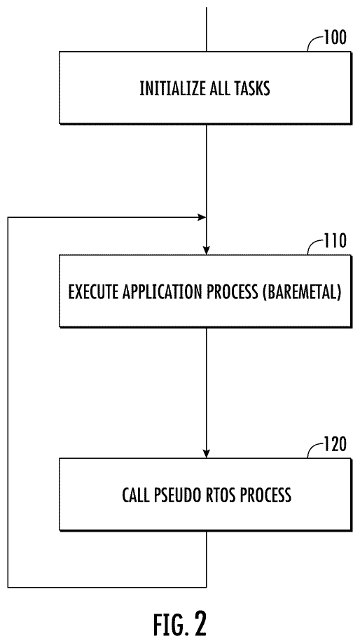

FIG. 2 shows the main loop that is executed in the bare metal environment. This main loop comprises a Box 100, where all of the tasks are initialized. These tasks are originally written to be executed in an RTOS environment. These tasks each include a Task Control Block (TCB). The TCB includes information regarding the tasks, such as its blocked status. It also includes a region or a pointer to a region that is designated as the stack for this task. During the initialization of the tasks, a list of TCBs is created.

As shown in FIG. 2, the main loop is an infinite loop that executes the application process (see Box 110) and a pseudo RTOS process (see Box 120). The application process is also referred to as the bare metal process. This application process is typically written by the end user and is used to perform some function. The pseudo RTOS process executes all of the tasks that were initialized in Box 100. Thus, in operation, once the tasks have been initialized, the system repeatedly executes the application process and the pseudo RTOS process.

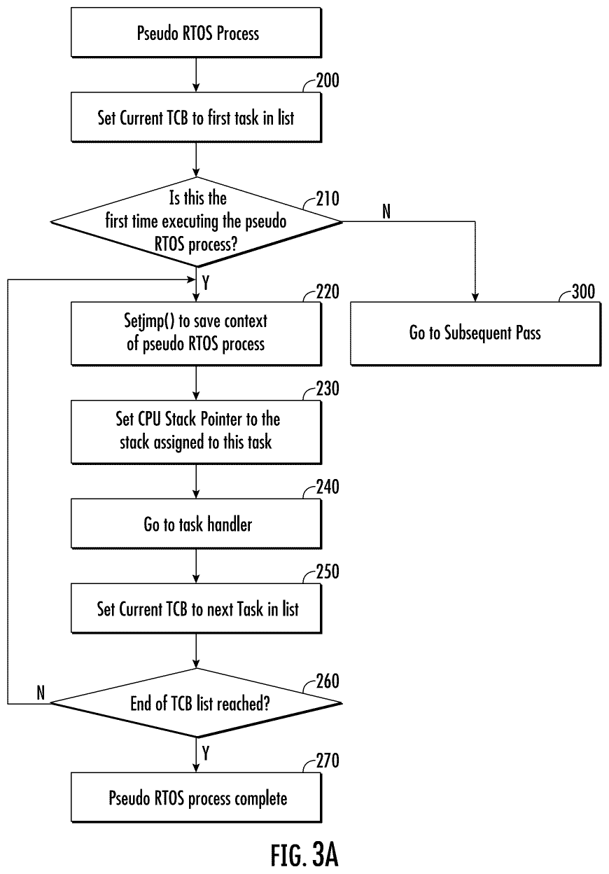

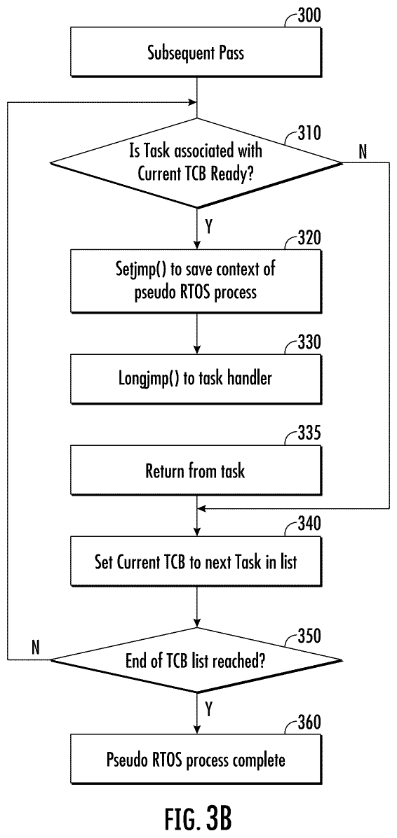

FIGS. 3A-3B show the pseudo RTOS process according to one embodiment. This pseudo RTOS process executes one set of instructions when it is executed for the first time (see FIG. 3A), and a second set of instructions when it is subsequently executed (see FIG. 3B).

First, as shown in Box 200, the variable “Current TCB” is set to the first task in the list. As noted above, this list was created in Box 100 of FIG. 2. Next, as shown in Decision Box 210, it is determined whether this is the first time that the pseudo RTOS process is being executed. If it is, the pseudo RTOS process saves the current state, as shown in Box 220. In one embodiment, the current state may be saved using a setjmp( ) instruction. The setjmp( ) instruction is a C instruction that saves the state of all of the registers in the processing unit 20, including the program counter (PC) and the stack pointer (SP) to an address specified as the argument in the instruction. The pseudo RTOS process then sets the stack pointer to the address specified in the TCB Of this task, as shown in Box 230. Then, the pseudo RTOS process jumps to the start of the handler for this task, as shown in Box 240. The address of the start of the handler may be obtained during the initialization shown in FIG. 2.

At some point, the task will be blocked, waiting for some event. This event may be a construct, such as a semaphore or a mutex. Alternatively, the event may be a time delay. When the task is blocked, control is returned to the pseudo RTOS process, as will be described in more detail below. The pseudo RTOS process then updates the Current TCB to the next task in the list, as shown in Box 250. If all of the tasks have not been processed, as determined in Decision Box 260, this sequence is repeated for the next task. Thus, Boxes 220-250 are repeated for each task. If there are no more tasks in the TCB list, then the pseudo RTOS process is complete, as shown in Box 270. In certain embodiments, the current TCB may be set to NULL to indicate that the pseudo RTOS process is no longer being executed.

Returning to Decision Box 210, if this is not the first time that the pseudo RTOS process is being executed, the processing unit executes a second set of instructions, referred to as Subsequent Pass (see Box 300), as shown in FIG. 3B. First, as shown in Decision Box 310, the pseudo RTOS process checks if the current task is ready to execute. For example, the task may be waiting on some event, and therefore should not be executed at this time. If the task is ready, then the pseudo RTOS process executes a setjmp( ) instructions to save the current state of the pseudo RTOS process, as shown in Box 320. In another embodiment, the pseudo RTOS process may maintain a list of tasks that are ready to execute, referred to as a ready list. In this embodiment, rather than checking if the current task is ready, it simply cycles through the ready list, aware that all of the tasks in the ready list are ready to execute. Thus, in this embodiment, Decision Box 310 may be omitted. In either embodiment, the pseudo RTOS process then executes a longjmp( ) instruction, as shown in Box 330.

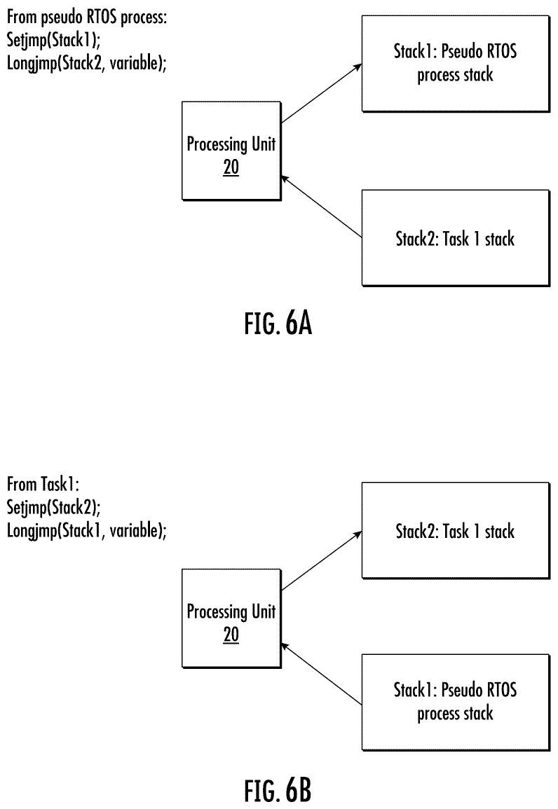

FIGS. 6A-6B show the operation of the setjmp( ) and longjmp( ) instructions. As shown in FIG. 6A, when the pseudo RTOS process executes a setjmp( ) instruction, the current state of the processing unit 20 is saved to a buffer identified in the argument passed to setjmp( ). In this figure, that argument points to Stack 1, which is a designated region in memory that contains the stack for the pseudo RTOS process. Thus, the setjmp( ) instruction saves the state to that stack. A longjmp( ) instruction executed by the pseudo RTOS process is used to load the last state of the task into the processing unit. 20. Specifically, the processing unit is loaded with the state that is found at the buffer identified in the argument passed to longjmp( ), which in this figure is a second designated region of memory that contains Stack 2, the stack for Task 1.

At a later time, the task returns control back to the pseudo RTOS process. This is shown in FIG. 6B. First, the task executes a setjmp( ) instruction, where the argument is a pointer to Stack 2. In this way, the current state of the task is saved in its stack. The task then executes a longjmp( ) instruction, where the argument is a pointer to Stack 1. In this way, the processing unit returns to the last state of the pseudo RTOS process. Note that longjmp( ) instructions return to a setjmp( ) instruction. Thus, the return value associated with the setjmp( ) instruction is used to determine the path used to get to the setjmp( ) instruction. If the setjmp( ) instruction was executed, it returns a value of 0. If the setjmp( ) instruction is executed as a result of a longjmp( ) instruction, a non-zero value is returned (which is the second argument in the longjmp( ) instruction). In this way, the code is able to know the current state of the pseudo RTOS process and the associated task.

Thus, after Box 330 is executed, the processing unit 20 is executing a task. When that task eventually is blocked, control is returned to the pseudo RTOS process, as shown in Box 335. The pseudo RTOS process then updates the Current TCB variable to the next task in the list, as shown in Box 340. If this is not the last task in the list (as determined in Decision Box 350), the pseudo RTOS process repeats this sequence for the next task. Thus, Boxes 310-350 are repeated for each task. When all of the tasks have been executed, the pseudo RTOS process is complete, as shown in Box 360.

Note that if a task is not ready to execute, it is skipped by the pseudo RTOS process by moving from Decision Box 310 directly to Box 340.

Thus, each time the main loop calls the pseudo RTOS process, it executes the flowchart shown in FIGS. 3A-3B.

While FIGS. 2 and 3A-3B describe the main loop that is executed by the bare metal environment, there are additional modifications that are needed to make the tasks fully functional in this environment. As described above, the tasks are written with a layer of abstraction between themselves and the underlying RTOS. Therefore, application programming interfaces (APIs) are used to represent a call to the RTOS. These APIs actually result in the execution of a set of instructions specific to the underlying RTOS. This set of instructions is the abstraction layer described above. This abstraction layer may also be used to allow these tasks to operate in a bare metal environment. In other words, the abstraction layer may be designed so that the tasks, which are written to have calls to an RTOS, may operate in a bare metal environment.

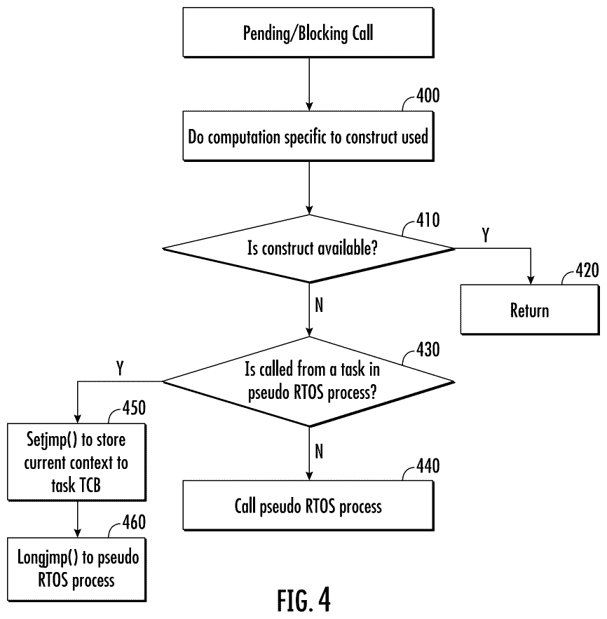

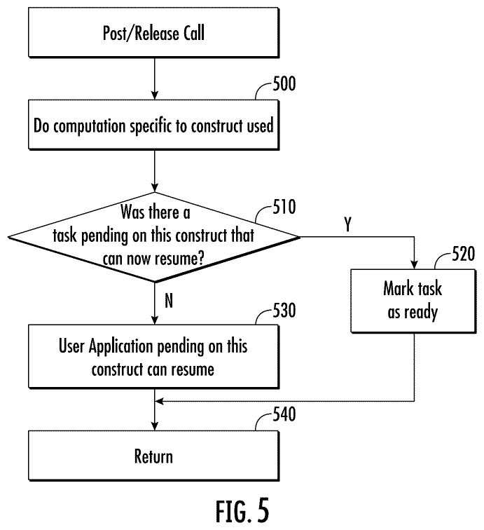

FIGS. 4-5 show the actual implementation of pending/blocking calls and post/release calls, respectively. A pending/blocking call is one in which the calling function, which may be a task or the application process, is waiting on an event before it can proceed any further. This may be a time delay, a semaphore or a mutex, as examples. A post/release call is one in which the calling function, which may be a task or the application process, frees a shared resource, such as a semaphore or a mutex. Each is described in more detail below.

FIG. 4 shows the flowchart of a pending/blocking call. The pending/blocking call may be made by either a task or by the user application. First, as shown in Box 400, the processing unit 20 performs the computation specific to the construct being used. For example, this may involve decrementing a semaphore count. After the computation is performed, the processing unit checks if the construct is available, as shown in Box 410. For example, if after decrementing a semaphore, it is still positive, the calling function is free to continue operation, as shown in Box 420. If the construct is not available, the processing unit 20 checks which function made this call, as shown in Decision Box 430. If this call was made by a task, it means that the task is now blocked. Thus, the current state of the task is saved using a setjmp( ) instruction, as shown in Box 450. As shown in Box 460, the processing unit 20 then executes a longjmp( ) instruction, which returns the processing unit back to the pseudo RTOS process. Further, the TCB of this task may be marked to indicate that the task is no longer ready so that it is not executed the next time the pseudo RTOS process is executed. These two boxes are also the same sequence as shown in FIG. 6B. If, on the other hand, the call was not made by a task, then the call was made by the user application. An indication that the user application is no longer ready to execute may be saved. In this case, the user application calls the pseudo RTOS process, as shown in Box 440. In some embodiments, the pseudo RTOS process may execute the loop shown in FIG. 3B until the user application is able to execute again.

FIG. 5 shows the flowchart of a post/release call. The post/release call may be made by either a task or by the user application. First, as shown in Box 500, the processing unit 20 performs the computation specific to the construct being used. For example, this may involve incrementing a semaphore count. As shown in Decision Box 510, the processing unit 20 checks whether a task was pending on this construct and is now ready to resume. If so, the TCB of this task is marked to indicate that the task is now ready, as shown in Box 520. Thus, the next time the pseudo RTOS process executes, this task will execute. If it was not a task that was pending on this construct, then it must have been the user application. Thus, as shown in Box 530, the user application can now execute again once the pseudo RTOS process completes. This completes the operation of the post/release call and the processing unit returns control to the calling function, as shown in Box 540.

While the above description uses setjmp( ) and longjmp( ) instructions, it is understood that other mechanisms may be used to perform the operations that are performed by these instructions. In other words, setjmp( ) and longjmp( ) are an illustration of how this operation may be performed, but the disclosure is not limited to this implementation. Any mechanism that can save the context of one process or task in one region and restore the context of a different process or task from a second region may be used.

Further, while FIGS. 4-5 show the flow chart associated with two types of RTOS calls, there are other RTOS calls that are also implemented using the abstraction layer to allow the tasks to operate in a bare metal environment.

The present system and method has many advantages. As noted above, many tasks are written for execution in an RTOS environment. However, there are customers wishing to run a bare metal environment. Rather than creating two versions of every task, the present system and method allow the same task to be used by both RTOS environments and bare metal environments. Thus, there is only one version of each task to be maintained and updated. Further, by using this abstraction layer and pseudo RTOS process, customers are able to decide which environment is preferable for their situation. The use of a bare metal environment may have some limitations that are not present when an RTOS is used. For example, real time operations may not be supported since there is no concept of preemption in a bare metal environment.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method to allow a plurality of tasks that are written for a real time operating system (RTOS) environment to execute in a bare metal environment, comprising:
executing an infinite loop that comprises a user application and a pseudo RTOS process;
wherein the pseudo RTOS process cycles through each of the plurality of tasks that are ready to execute; and
wherein when the pseudo RTOS process switches to a first of the plurality of tasks, its context is saved in a first designated region of memory; and
wherein when the first of the plurality of tasks is blocked, the context stored in the first designated region of memory is restored to allow the pseudo RTOS process to continue execution.

2. The method of claim 1, wherein the pseudo RTOS process loads context stored in a second designated region of memory to switch to the first of the plurality of tasks.

3. The method of claim 2, wherein setjmp( ) and longjmp( ) instructions are used to save and load context to and from designated regions of memory.

4. The method of claim 2, wherein the first of the plurality of tasks becomes blocked after performing a pending/blocking call.

5. The method of claim 4, wherein the pending/blocking call comprises:
performing a computation on a selected construct;
and if the selected construct is not available:
storing context of the first of the plurality of tasks in the second designated region of memory; and
loading the context from the first designated region of memory to switch to the pseudo RTOS process.

6. The method of claim 5, wherein the pending/blocking call further comprises: indicating that the first of the plurality of tasks is not ready to execute.

7. The method of claim 5, wherein the first of the plurality of tasks becomes ready after a second of the plurality of tasks executes a post/release call.

8. The method of claim 7, wherein the post/release call comprises:
performing a computation on the selected construct; and
marking the first of the plurality of tasks as ready.

9. The method of claim 1, wherein the plurality of tasks utilize RTOS functions, wherein the plurality of tasks utilize RTOS calls that are coded as application programming interfaces (APIs), and an abstraction layer is provided to allow the RTOS functions to be performed in the bare metal environment.

10. A method to allow a plurality of tasks that are written for a real time operating system (RTOS) environment to execute in a bare metal environment, comprising:
including RTOS functions in the plurality of tasks, wherein each RTOS call is coded as application programming interfaces (APIs); and
providing an abstraction layer, wherein the abstraction layer comprises instructions that to allow the RTOS functions to be performed in the bare metal environment.

11. The method of claim 10, wherein one of the RTOS calls comprises a pending/blocking call.

12. The method of claim 11, wherein the pending/blocking call comprises:
performing a computation on a selected construct;
and if the selected construct is not available:
storing context of a task that is executing in
a second designated region of memory; and
loading context from a first designated region of memory to switch to a pseudo RTOS process.

13. The method of claim 12, wherein the pending/blocking call further comprises:
indicating that the task is not ready to execute.

14. The method of claim 10, wherein a pseudo RTOS process is used to cycle through all tasks that are ready to execute to allow each task to execute once.

15. The method of claim 14, wherein the plurality of tasks and the pseudo RTOS process use setjmp( ) and longjmp( ) instructions to switch context.

16. The method of claim 10, wherein one of the RTOS calls comprises a post/release call.

17. The method of claim 16, wherein the post/release call comprises:
performing a computation on a selected construct; and
marking a task or a user application that was waiting on the selected construct as ready to execute.
